(19) United States
(12) Patent Application Publication
(10) Pub. No.: US 2025/0289274 A1
(43) Pub. Date: Sep. 18, 2025

(54) UNIVERSAL TRACTOR TOWING DEVICE

(71) Applicant: WEIFANG AIRUI BRAKE SYSTEMS CO., LTD., WEIFANG (CN)

(72) Inventors: XIANGBO FENG, WEIFANG (CN); YUANXUE ZHOU, WEIFANG (CN); YAN LIU, WEIFANG (CN)

(21) Appl. No.: 18/946,931

(22) Filed: Nov. 14, 2024

(30) Foreign Application Priority Data
Mar. 15, 2024 (CN) 202410295727.0

(51) Int. Cl. B60D 1/02; B60D 1/24

(52) U.S. Cl. CPC B60D 1/025; B60D 1/242

(57) ABSTRACT

The present invention relates to the technical field of towing devices, and in particular to a universal tractor towing device. The bottom of a towing pin is fixedly fitted onto a mounting base, a top end of a pin column at the top of the towing pin is provided with a limiting ring groove, a tow device seat includes a cylindrical seat longitudinally fixed to a top surface of a front end of a towing frame, a connector includes a connecting part that is rotatably sleeved at the bottom of the pin column and a shackle assembly whose bottom end is rotatably sleeved with a top end of the connecting part, such that the comfort and safety of a towed vehicle are greatly improved under off-road conditions.

### TECHNICAL FIELD

The present invention relates to the technical field of towing devices, and in particular to a universal tractor towing device.

### BACKGROUND ART

With the development of science and technology and economy, towable RVs and tractors are becoming increasingly popular in the domestic market. A connection device between the tractor (towing vehicle) and the RV (towed vehicle) plays a vital role in the safety and comfort of the whole RV and tractor during driving.

At present, the mainstream connection mode in the industry is ball joint connection, that is, a ball joint is installed at the tail of the towing vehicle and a ball joint cover is installed at the front end of the towed vehicle. Although the structure is relatively simple, it is easy to come off and cannot achieve universal conversion. The comfort and safety of the towing vehicle and the towed vehicle are poor under off-road conditions, and when the towed vehicle travels on roads with excessive pitch angles or left and right undulation angles, it is easy to affect the towing vehicle.

### SUMMARY OF THE INVENTION

The purpose of the present invention is to provide a universal tractor towing device to solve the problem in the prior art that the towed vehicle has poor comfort and safety when travelling under off-road conditions.

To achieve the above purpose, the present invention provides a technical solution as follows: a universal tractor towing device, which comprises a mounting base fixed on a rear end of a towing vehicle and a towing frame fixed on a front end of a towed vehicle, and also comprises a towing pin, a tow device seat, a connector and a towbar, wherein the bottom of the towing pin is fixedly fitted onto the mounting base, the top of the towing pin is provided with a pin column, and a top end of an outer peripheral wall of the pin column is provided with a limiting ring groove, the tow device seat comprises a cylindrical seat longitudinally fixed to a top surface of a front end of the towing frame, the connector comprises a connecting part that is rotatably sleeved at the bottom of the pin column and a shackle assembly whose bottom end is rotatably sleeved with a top end of the connecting part, two sides of the center of the top end of the connecting part are respectively provided with paddles which can be stuck into the limiting ring groove through horizontal swinging, an inner cavity of the shackle assembly is provided with driving mechanisms that drive the two paddles to swing horizontally at the same time when rotating synchronously with the shackle assembly, the shackle assembly is provided with a locking mechanism to restrict its rotation, the towbar comprises a rod member that is rotatably sleeved in an inner cavity of the cylindrical seat and a C-shaped member fixed to a front end of the rod member, and two side walls at the front end of the C-shaped member are respectively rotatably inserted with rotating shaft pins whose inner ends are fixedly connected to two side walls of the connecting part.

Preferably, the towing pin further comprises a disc supported on a top surface of a rear end of the mounting base, a screw fixed at the center of a bottom surface of the disc and penetrating the mounting base, and a nut threaded around a bottom end of the screw, a bottom end of the pin column being fixed in the middle of a top surface of the disc.

Preferably, the cylindrical seat is vertically provided with vertical holes at positions near four corners respectively, first bolts whose bottom ends are fixedly connected to the towing frame are inserted in the vertical holes, and bushings are inserted between the rod member and front and rear ends of an inner cavity of the cylindrical seat respectively.

Preferably, a side wall of a middle part of the cylindrical seat is provided with a grease hole, and a grease nozzle is inserted in the grease hole.

Preferably, the connecting part further comprises a base that is rotatably sleeved at the bottom of the pin column, a pair of arc-shaped grooves are provided on front and rear sides of the center of a top surface of the base in a centrally symmetrical relationship, the paddles are vertically inserted with vertical shafts at ends located close to each other, and bottom ends of the vertical shafts are slidably stuck into the arc-shaped grooves, the other ends of the paddles are provided with through holes that extend vertically, and first screws whose bottom ends are threaded onto the top surface of the base are rotatably inserted into the through holes.

Preferably, limiting holes are provided on two sides of the center of the top surface of the base in an axially symmetrical relationship, the top surface of the base is provided with an annular groove near the outer edge, the shackle assembly comprises a housing whose bottom end rotatably fitted in the annular groove, a limiting rod whose top column is vertically fitted in the top center of the housing in a sliding way and two sides of the bottom end of which are respectively inserted and matched with limiting holes, a knob provided above the housing, and a second screw which is vertically fitted in the middle of the knob and the bottom end of which is matched with the top surface of the limiting rod in a threaded socket manner, the driving mechanisms being provided in an inner cavity of the housing.

Preferably, the center of the top of the housing is provided with a socket hole that is matched with the top of the limiting rod in a vertical sliding socket manner, the side wall of the inner cavity of the housing is provided with guide grooves that are clamped and matched with two sides of the bottom of the limiting rod in a vertical sliding manner, the bottom end of the top column of the limiting rod is sleeved with a first spring, there is a fixing flange on a bottom periphery of the housing, the fixing flange is evenly inserted with third screws that extend vertically respectively along the circumferential direction, and bottom ends of the third screws are threaded onto an outer edge of the top surface of the base.

Preferably, the driving mechanisms are driving grooves provided on two sides of an inner cavity of the housing, and top ends of the vertical shafts are stuck into the driving grooves.

Preferably, the rear end of the rod member is sleeved with a flange nut, and the rear end of the rod member is radially inserted with an expansion pin for preventing the flange nut from falling off the rear end of the rod member.

Preferably, the universal tractor towing device further comprises a handbrake mechanism, wherein the rear end of the cylindrical seat is fixedly connected with a protective connection cover, the handbrake mechanism comprises a ratchet plate whose front end is fixedly connected to a rear side wall of the protective connection cover, a connecting arm whose middle part is rotatably connected to the bottom of a rear side wall of the ratchet plate, a pipe fitting whose rear end is fixed to a top end of the connecting arm, a handle sheath which is sleeved at a front end of the pipe fitting, a detent which is provided at a top end of an inner cavity of the connecting arm, a push rod which is sleeved in the pipe fitting and a rear end of which is rotatably connected to a top end of the detent, a button which is slidably sleeved at a front end of an inner cavity of the handle sheath and a rear end of which is fixedly connected to a front end of the push rod, and a second spring sleeved at a position near the front end of the push rod, a bottom end of the connecting arm is provided with cable holes fixedly connected with a front end of a brake cable of the towed vehicle, a middle part of the detent is inserted with a connecting shaft, two ends of the connecting shaft are respectively rotatably fitted onto inner cavity side walls at the top end of the connecting arm, there is a front limiter located on a front side of the second spring on the push rod, and there is a rear limiter located on a position corresponding to a rear side of the second spring on the pipe fitting.

Compared with the prior art, the beneficial effects of the present invention are as follows.

The present invention relates to a universal tractor towing device that can relatively swing left and right in a horizontal direction, swing in a vertical direction and rotate axially, so as to realize normal driving of a towing vehicle and a towed vehicle on off-road roads such as roads with large pitch angle and left and right undulating roads, and avoid the vehicle from rolling over and losing grip.

The connector in the universal tractor towing device involved in the present invention can be assembled and disassembled with the towing pin quickly and flexibly, making it easy to operate; and it is provided with a locking mechanism to avoid decoupling during driving.

### BRIEF DESCRIPTION OF THE DRAWINGS

FIG. 1 is a schematic diagram of an overall three-dimensional structure of the present invention;

FIG. 2 is a schematic three-dimensional structural diagram of a towing pin of the present invention;

FIG. 3 is a schematic exploded structural diagram of a tow device seat of the present invention;

FIG. 4 is a schematic exploded structural diagram of a connector of the present invention;

FIG. 5 is a schematic exploded structural diagram of a connecting part of the present invention;

FIG. 6 is a schematic exploded structural diagram of a shackle assembly of the present invention;

FIG. 7 is a schematic diagram of a bottom view structure of a housing of the present invention;

FIG. 8 is a schematic exploded structural diagram of a towbar of the present invention;

FIG. 9 is a three-dimensional structural diagram of a protective connection cover of the present invention; and

FIG. 10 is a schematic exploded structural diagram of a handbrake mechanism of the present invention.

In the figures: 1—mounting base, 2—towing frame, 3—towing pin, 3.1—disc, 3.2—screw, 3.3—nut, 3.4—pin column, 3.4.1—limiting ring groove, 4—tow device seat, 4.1—cylindrical seat, 4.1.1—vertical hole, 4.1.2—grease hole, 4.2—bushing, 4.3—grease nozzle, 4.4—first bolt, 5—connector, 5.1—connecting part, 5.1.1—base, 5.1.1.1—annular groove, 5.1.1.2—arc-shaped groove, 5.1.1.3—limiting hole, 5.1.2—paddle, 5.1.2.1—through hole, 5.1.2.2—vertical shaft, 5.1.3—first screw, 5.2—shackle assembly, 5.2.1—housing, 5.2.1.1—socket hole, 5.2.1.2—drive groove, 5.2.1.3—guide groove, 5.2.2—limiting rod, 5.2.3—first spring, 5.2.4—knob, 5.2.5—second screw, 5.3—fixing flange, 5.4—third screw, 6—towbar, 6.1—rod member, 6.2—C-shaped member, 6.3—flange nut, 6.4—expansion pin, 6.5—rotating shaft screw, 7—protective connection cover, 8—handbrake mechanism, 8.1—pipe fitting, 8.1.1—rear limiter, 8.2—connecting arm, 8.2.1—cable hole, 8.3—ratchet plate, 8.4—handle sheath, 8.5—detent, 8.5.1—connecting shaft, 8.6—push rod, 8.6.1—front limiter, 8.7—second spring, 8.8—button.

### DETAILED DESCRIPTION OF EMBODIMENTS

The technical solution in the embodiments of the present invention will be described clearly and completely below in conjunction with the accompanying drawings for the embodiments of the present invention; and obviously, the embodiments described are merely some, rather than all, of the embodiments of the present invention. All other embodiments obtained by those of ordinary skills in the art based on the embodiments of the present invention without any creative efforts shall all fall within the protection scope of the present invention.

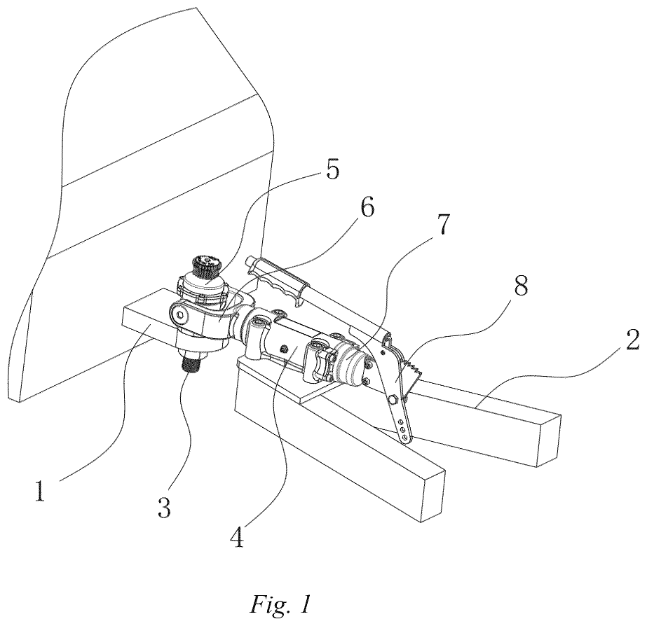

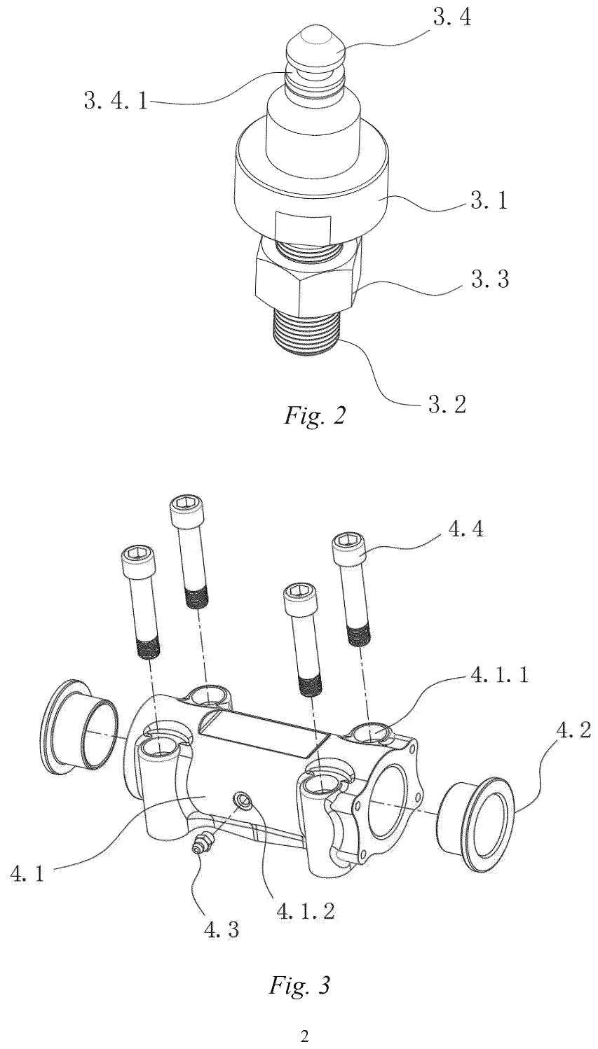

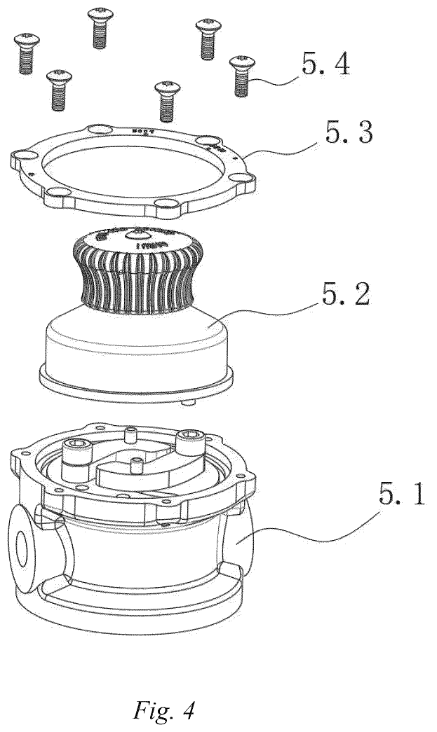

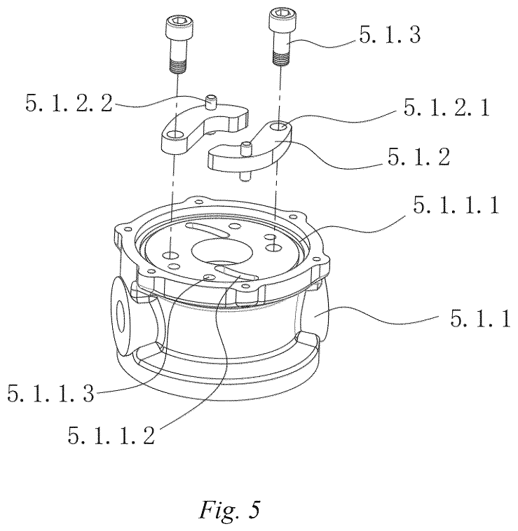

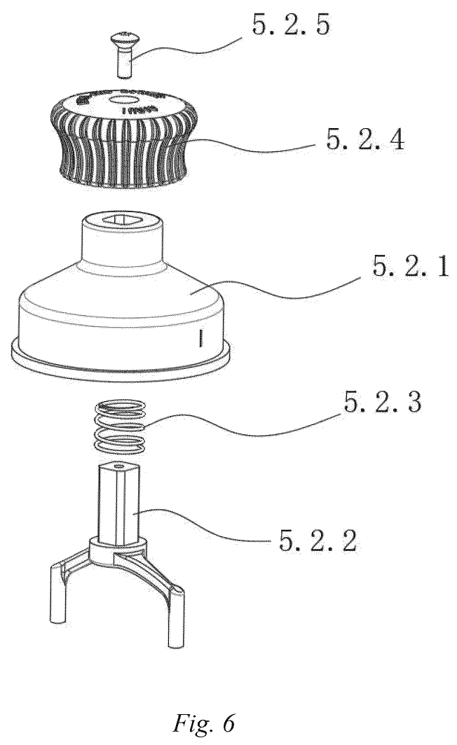

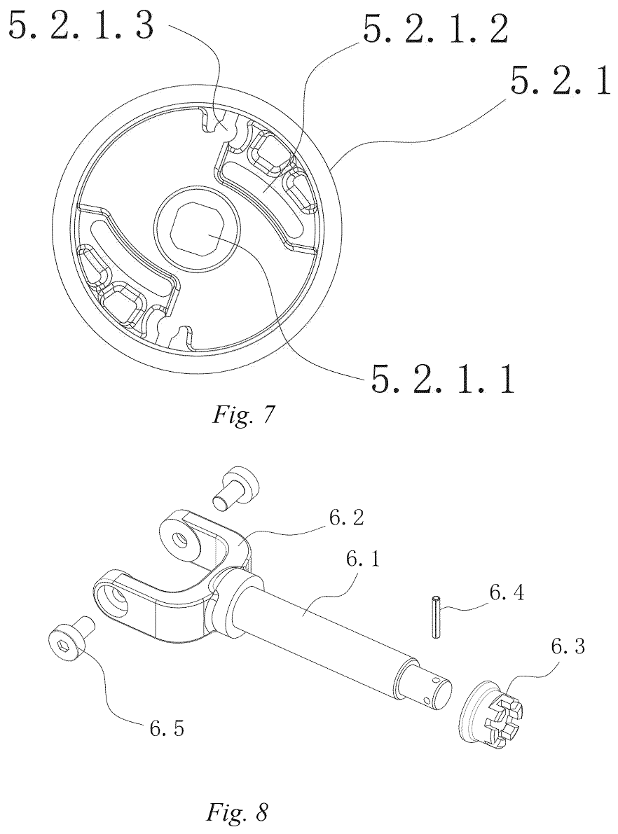

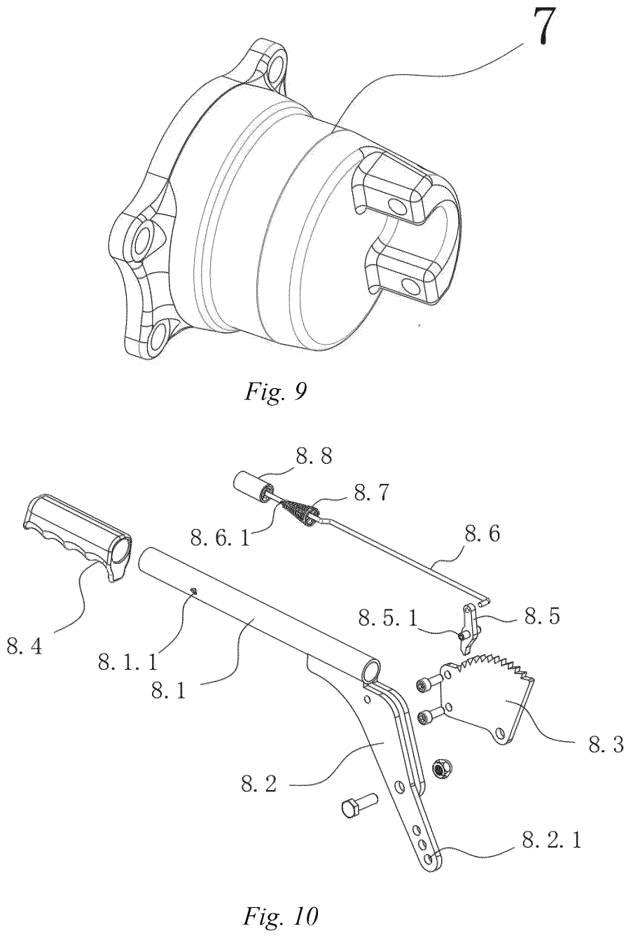

Referring to FIGS. 1-10, the present invention provides a technical solution, a universal tractor towing device, which includes a mounting base 1 fixed on a rear end of a towing vehicle and a towing frame 2 fixed on a front end of a towed vehicle.

A towing pin 3 includes a disc 3.1 supported on a top surface of a rear end of the mounting base 1, a screw 3.2 fixed at the center of a bottom surface of the disc 3.1 and penetrating the mounting base 1, a nut 3.3 threaded around a bottom end of the screw 3.2, and a pin column 3.4 whose bottom end is fixed in the middle of a top surface of the disc 3.1. A top end of an outer peripheral wall of the pin column 3.4 is provided with a limiting ring groove 3.4.1, and the top of the pin column 3.4 is in a shape of a circular truncated cone to improve the convenience of installation with a connector 5.

A tow device seat 4 includes a cylindrical seat 4.1 longitudinally fixed to a top surface of a front end of the towing frame 2, where the cylindrical seat 4.1 is vertically provided with vertical holes 4.1.1 at positions near four corners respectively, first bolts 4.4 whose bottom ends are fixedly connected to the towing frame 2 are inserted in the vertical holes 4.1.1, and front and rear ends of an inner cavity of the cylindrical seat 4.1 are respectively inserted with bushings 4.2.

A towbar 6 includes a rod member 6.1 whose front and rear ends are respectively rotatably inserted in the bushings 4.2 and a C-shaped member 6.2 fixed at the front end of the rod member 6.1. Two side walls at the front end of the C-shaped member 6.2 are respectively inserted with rotating shaft pins 6.5. The rear end of the rod member 6.1 is sleeved with a flange nut 6.3, and the rear end of the rod member 6.1 is radially inserted with an expansion pin 6.4 for preventing the flange nut 6.3 from falling off the rear end of the rod member 6.1. Therefore, the axial sliding of the rod member 6.1 relative to the cylindrical seat 4.1 is limited. The rod member 6.1 and the C-shaped member 6.2 may be fixedly connected by welding, or the two structures may be integrally forged/cast.

A side wall of a middle part of the cylindrical seat 4.1 is provided with a grease hole 4.1.2, and a grease nozzle 4.3 is inserted in the grease hole 4.1.2. It is convenient to add lubricating grease between the cylindrical seat 4.1 and the rod member 6.1 through the grease nozzle 4.3 to improve the smoothness of the rotation of the rod member 6.1 relative to the cylindrical seat 4.1.

The rear end of the cylindrical seat 4.1 is fixedly connected with a protective connection cover 7. A handbrake mechanism 8 includes a ratchet plate 8.3 whose front end is fixedly connected to a rear side wall of the protective connection cover 7, a connecting arm 8.2 whose middle part is rotatably connected to the bottom of a rear side wall of the ratchet plate 8.3, a pipe fitting 8.1 whose rear end is fixed to a top end of the connecting arm 8.2, a handle sheath 8.4 which is sleeved at a front end of the pipe fitting 8.1, a detent 8.5 which is provided at a top end of an inner cavity of the connecting arm 8.2, a push rod 8.6 which is sleeved in the pipe fitting 8.1 and a rear end of which is rotatably connected to a top end of the detent 8.5, a button 8.8 which is slidably sleeved at a front end of an inner cavity of the handle sheath 8.4 and a rear end of which is fixedly connected to a front end of the push rod 8.6, and a second spring 8.7 sleeved at a position near the front end of the push rod 8.6. A bottom end of the connecting arm 8.2 is provided with cable holes 8.2.1 fixedly connected with a front end of a brake cable of the towed vehicle. A middle part of the detent 8.5 is inserted with a connecting shaft 8.5.1. Two ends of the connecting shaft 8.5.1 are respectively rotatably fitted onto inner cavity side walls at the top end of the connecting arm 8.2. There is a front limiter 8.6.1 located on a front side of the second spring 8.7 on the push rod 8.6. There is a rear limiter 8.1.1 located on a position corresponding to a rear side of the second spring 8.7 on the pipe fitting 8.1. That is, with the handbrake mechanism 8, it is convenient to pull the brake cable, so that the towed vehicle is in a braking state when parking. During the braking operation, the pipe fitting 8.1 is lifted upward through the handle sheath 8.4, so that the middle part of the connecting arm 8.2 swings upward relative to the ratchet plate 8.3, so that a bottom end of the detent 8.5 is engaged with brake teeth at the rear of the ratchet plate 8.3. At this time, due to the action of the second spring 8.7, the push rod 8.6 is in a forward motion trend to achieve the braking of the connecting arm 8.2. The bottom end of the connecting arm 8.2 swings to the most front end, so that the brake cable is in a taut state to maintain the braking state of the towed vehicle. When it is necessary to release the braking state, by pressing the button 8.8, the second spring 8.7 is compressed backward by the front limiter 8.6.1, so that the push rod 8.6 can move backward, thereby pushing a top end of the detent 8.5 backward, so that the bottom end of the detent 8.5 is detached from the brake teeth of the ratchet plate 8.3, and by keeping the button 8.8 pressed and swinging the pipe fitting 8.1 downward, the relaxation of the brake cable is realized, so as to complete the operation of releasing the brake.

The connector 5 includes a connecting part 5.1, a shackle assembly 5.2, a fixing flange 5.3 and third screws 5.4. The connecting part 5.1 includes a base 5.1.1 that is rotatably sleeved at the bottom of the pin column 3.4. A pair of arc-shaped grooves 5.1.1.2 are provided on front and rear sides of the center of the top surface of the base 5.1.1 in a centrally symmetrical relationship. Two sides of the center of the top end of the base 5.1.1 are respectively provided with paddles 5.1.2. The paddles 5.1.2 are vertically inserted with vertical shafts 5.1.2.2 at ends located close to each other, and bottom ends of the vertical shafts 5.1.2.2 are slidably stuck into the arc-shaped grooves 5.1.1.2. The other ends of the paddles 5.1.2 are provided with through holes 5.1.2.1 that extend vertically. First screws 5.1.3 whose bottom ends are threaded onto the top surface of the base 5.1.1 are rotatably inserted into the through holes 5.1.2.1. Inner ends of rotating shaft screws 6.5 are respectively threaded onto two side walls of the base 5.1.1. When the two paddles 5.1.2 swing horizontally toward each other, they may be stuck into the limiting ring groove 3.4.1 at the same time. When the two paddles 5.1.2 swing horizontally outwards, they may be detached from the limiting ring groove 3.4.1.

An inner cavity of the shackle assembly 5.2 is provided with driving mechanisms that drive the two paddles 5.1.2 to swing horizontally at the same time when rotating synchronously with the shackle assembly 5.2, and the shackle assembly 5.2 is provided with a locking mechanism to restrict its rotation.

To sum up, when the towing vehicle is connected, a central shaft hole of the base 5.1.1 is sleeved on the pin column 3.4. Firstly, the shackle assembly 5.2 is rotated to make the two paddles 5.1.2 swing horizontally outwards through the driving mechanisms, so that the top end of the pin column 3.4 can smoothly pass through the space between the two paddles 5.1.2, and the limiting ring groove 3.4 is just in the same horizontal plane with the paddles 5.1.2. Then the shackle assembly 5.2 is rotated in an opposite direction, so that the paddles 5.1.2 are stuck into the limiting ring groove 3.4, and the locking mechanism restricts the rotation of the shackle assembly 5.2, so that the connection operation of the towing vehicle may be quickly completed. When the towing vehicle pulls the towed vehicle to travel, the C-shaped member 6.2 may swing up and down relative to the base 5.1.1, thereby allowing the towing vehicle and the towed vehicle to smoothly pass through roads with large pitch angles and avoiding the loss of grip of the wheel tires. Since the base 5.1.1 can rotate horizontally relative to the pin column 3.4, the towed vehicle can adapt to the turning of the towing vehicle. The rod member 6.1 can rotate relative to the cylindrical seat 4.1, so that the towing vehicle and the towed vehicle can pass smoothly when travelling on left and right undulating roads and avoid rollover.

As for the driving mechanisms, the driving mechanisms may be driving grooves 5.2.1.2 provided on two sides of an inner cavity of a housing 5.2.1, and top ends of the vertical shafts 5.1.2.2 are stuck into the driving grooves 5.2.1.2. That is, when the housing 5.2.1 is rotated, the driving grooves 5.2.1.2 push the paddles 5.1.2 to swing horizontally through the top ends of the vertical shafts 5.1.2.2. The driving mechanisms may also be mechanisms that are provided in the inner cavity of the housing 5.2.1 and drive the paddles 5.1.2 to swing horizontally through gear transmission with the paddles 5.1.2 or other means.

For the locking mechanism, limiting holes 5.1.1.3 are provided on two sides of the center of the top surface of the base 5.1.1 in an axially symmetrical relationship, and the top surface of the base 5.1.1 is provided with an annular groove 5.1.1.1 near the outer edge. The shackle assembly 5.2 includes the housing 5.2.1 whose bottom end rotatably fitted in the annular groove 5.1.1.1; a limiting rod 5.2.2, whose top column is vertically fitted in the top center of the housing 5.2.1 in a sliding way, and two sides of the bottom end of which are respectively inserted and matched with limiting holes 5.1.1.3; a knob 5.2.4 provided above the housing 5.2.1; and a second screw 5.2.5 which is vertically sleeved in the middle of the knob 5.2.4, and the bottom end of which is matched with the top surface of the limiting rod 5.2.2 in a threaded socket manner. The bottom end of the top column of the limiting rod 5.2.2 is sleeved with a first spring 5.2.3. The limiting rod 5.2.2 is pulled upward through the knob 5.2.4, so that the bottom of the limiting rod 5.2.2 compresses the spring 5.2.3 upward and moves upward, so that insertion rods on two sides of the bottom end of the limiting rod 5.2.2 are detached from the limiting holes 5.1.1.3. At this time, the housing 5.2.1 and the limiting rod 5.2.2 can be rotated through the knob 5.2.4 to realize the rotation of the housing 5.2.1, and the paddles 5.1.2 can be driven to swing horizontally by the driving mechanisms. When the knob 5.2.4 is loosened, under the action of the first spring 5.2.3, the bottom end of the limiting rod 5.2.2 is re-inserted into the limiting holes 5.1.1.3 to restrict the rotation of the housing 5.2.1 again.

The center of the top of the housing 5.2.1 is provided with a socket hole 5.2.1.1 that is matched with the top of the limiting rod 5.2.2 in a vertical sliding socket manner. The socket hole 5.2.1.1 may be a square hole, a polygonal hole, a spline hole, etc. The top of the limiting rod 5.2.2 is a column structure with a corresponding cross-section.

The side wall of the inner cavity of the housing 5.2.1 is provided with guide grooves 5.2.1.3 that are clamped and matched with the two sides of the bottom of the limiting rod 5.2.2 in a vertical sliding manner to improve the rigidity between the limiting rod 5.2.2 and the housing 5.2.1.

There is a fixing flange 5.3 on the bottom periphery of the housing 5.2.1. The fixing flange 5.3 is evenly inserted with third screws 5.4 that extend vertically respectively along the circumferential direction. Bottom ends of the third screws 5.4 are threaded onto an outer edge of the top surface of the base 5.1.1. That is, the edge of the bottom end of the housing 5.2.1 is pressed and limited by the fixing flange 5.3 to prevent the housing 5.2.1 from loosening from the base 5.1.1.

In addition, the locking mechanism may also be a locking mechanism provided on the side of the housing 5.2.1, as long as it can restrict the rotation of the housing 5.2.1 relative to the base 5.1.1 and facilitate unlocking.

It should be noted that, in this document, relational terms such as “first” and “second” are only used to distinguish one entity or operation from another entity or operation, and do not necessarily require or imply the existence of any such actual relationship or order between these entities or operations. Furthermore, terms “include”, “contain” or any other variation thereof are intended to cover a non-exclusive inclusion, such that a process, method, article or device that includes a series of elements includes not only those elements, but also other elements not explicitly listed, or elements inherent to such process, method, article or device.

Although the embodiments of the present invention have been shown and described, it can be understood by those of ordinary skills in the art that various changes, modifications, substitutions and variations can be made to these embodiments without departing from the principles and spirit of the present invention, and the scope of the present invention is defined by the appended claims and their equivalents.

1. A universal tractor towing device, comprising a mounting base (1) fixed on a rear end of a towing vehicle and a towing frame (2) fixed on a front end of a towed vehicle, wherein further comprising:
a towing pin (3), the bottom of the towing pin (3) being fixedly fitted onto the mounting base (1), the top of the towing pin (3) being provided with a pin column (3.4), and a top end of an outer peripheral wall of the pin column (3.4) being provided with a limiting ring groove (3.4.1);
a tow device seat (4), the tow device seat (4) comprising a cylindrical seat (4.1) longitudinally fixed to a top surface of a front end of the towing frame (2);
a connector (5), the connector (5) comprising a connecting part (5.1) that is rotatably sleeved at the bottom of the pin column (3.4) and a shackle assembly (5.2) whose bottom end is rotatably sleeved with a top end of the connecting part (5.1), two sides of the center of the top end of the connecting part (5.1) being respectively provided with paddles (5.1.2) which can be stuck into the limiting ring groove (3.4.1) through horizontal swinging, an inner cavity of the shackle assembly (5.2) being provided with driving mechanisms that drive the two paddles (5.1.2) to swing horizontally at the same time when rotating synchronously with the shackle assembly, and the shackle assembly (5.2) being provided with a locking mechanism to restrict its rotation; and
a towbar (6), the towbar (6) comprising a rod member (6.1) that is rotatably sleeved in an inner cavity of the cylindrical seat (4.1) and a C-shaped member (6.2) fixed to a front end of the rod member (6.1), two side walls at the front end of the C-shaped member (6.2) being respectively rotatably inserted with rotating shaft pins (6.5) whose inner ends are fixedly connected to two side walls of the connecting part (5.1).

2. The universal tractor towing device according to claim 1, wherein the towing pin (3) further comprises a disc (3.1) supported on a top surface of a rear end of the mounting base (1), a screw (3.2) fixed at the center of a bottom surface of the disc (3.1) and penetrating the mounting base (1), and a nut (3.3) threaded around a bottom end of the screw (3.2), a bottom end of the pin column (3.4) being fixed in the middle of a top surface of the disc (3.1).

3. The universal tractor towing device according to claim 1, wherein the cylindrical seat (4.1) is vertically provided with vertical holes (4.1.1) at positions near four corners respectively, first bolts (4.4) whose bottom ends are fixedly connected to the towing frame (2) are inserted in the vertical holes (4.1.1), and bushings (4.2) are inserted between the rod member (6.1) and front and rear ends of an inner cavity of the cylindrical seat (4.1) respectively.

4. The universal tractor towing device according to claim 1, wherein a side wall of a middle part of the cylindrical seat (4.1) is provided with a grease hole (4.1.2), and a grease nozzle (4.3) is inserted in the grease hole (4.1.2).

5. The universal tractor towing device according to claim 1, wherein the connecting part (5.1) further comprises a base (5.1.1) that is rotatably sleeved at the bottom of the pin column (3.4), a pair of arc-shaped grooves (5.1.1.2) are provided on front and rear sides of the center of a top surface of the base (5.1.1) in a centrally symmetrical relationship, the paddles (5.1.2) are vertically inserted with vertical shafts (5.1.2.2) at ends located close to each other, and bottom ends of the vertical shafts are slidably stuck into the arc-shaped grooves (5.1.1.2), the other ends of the paddles (5.1.2) are provided with through holes (5.1.2.1) that extend vertically, and first screws (5.1.3) whose bottom ends are threaded onto the top surface of the base (5.1.1) are rotatably inserted into the through holes (5.1.2.1).

6. The universal tractor towing device according to claim 5, wherein limiting holes (5.1.1.3) are provided on two sides of the center of the top surface of the base (5.1.1) in an axially symmetrical relationship, the top surface of the base (5.1.1) is provided with an annular groove (5.1.1.1) near the outer edge, the shackle assembly (5.2) comprises a housing (5.2.1) whose bottom end rotatably fitted in the annular groove (5.1.1.1), a limiting rod (5.2.2) whose top column is vertically fitted in the top center of the housing (5.2.1) in a sliding way and two sides of the bottom end of which are respectively inserted and matched with limiting holes (5.1.1.3), a knob (5.2.4) provided above the housing (5.2.1), and a second screw (5.2.5) which is vertically fitted in the middle of the knob (5.2.4) and the bottom end of which is matched with the top surface of the limiting rod (5.2.2) in a threaded socket manner, the driving mechanisms being provided in an inner cavity of the housing (5.2.1).

7. The universal tractor towing device according to claim 6, wherein the center of the top of the housing (5.2.1) is provided with a socket hole (5.2.1.1) that is matched with the top of the limiting rod (5.2.2) in a vertical sliding socket manner, the side wall of the inner cavity of the housing (5.2.1) is provided with guide grooves (5.2.1.3) that are clamped and matched with two sides of the bottom of the limiting rod (5.2.2) in a vertical sliding manner, the bottom end of the top column of the limiting rod (5.2.2) is sleeved with a first spring (5.2.3), there is a fixing flange (5.3) on a bottom periphery of the housing (5.2.1), the fixing flange (5.3) is evenly inserted with third screws (5.4) that extend vertically respectively along the circumferential direction, and bottom ends of the third screws (5.4) are threaded onto an outer edge of the top surface of the base (5.1.1).

8. The universal tractor towing device according to claim 6, wherein the driving mechanisms are driving grooves (5.2.1.2) provided on two sides of an inner cavity of the housing (5.2.1), and top ends of the vertical shafts (5.1.2.2) are stuck into the driving grooves (5.2.1.2).

9. The universal tractor towing device according to claim 1, wherein a rear end of the rod member (6.1) is sleeved with a flange nut (6.3), and the rear end of the rod member (6.1) is radially inserted with an expansion pin (6.4) for preventing the flange nut (6.3) from falling off the rear end of the rod member (6.1).

10. The universal tractor towing device according to claim 1, wherein further comprising a handbrake mechanism (8), wherein the rear end of the cylindrical seat (4.1) is fixedly connected with a protective connection cover (7), the handbrake mechanism (8) comprises a ratchet plate (8.3) whose front end is fixedly connected to a rear side wall of the protective connection cover (7), a connecting arm (8.2) whose middle part is rotatably connected to the bottom of a rear side wall of the ratchet plate (8.3), a pipe fitting (8.1) whose rear end is fixed to a top end of the connecting arm (8.2), a handle sheath (8.4) which is sleeved at a front end of the pipe fitting (8.1), a detent (8.5) which is provided at a top end of an inner cavity of the connecting arm (8.2), a push rod (8.6) which is sleeved in the pipe fitting (8.1) and a rear end of which is rotatably connected to a top end of the detent (8.5), a button (8.8) which is slidably sleeved at a front end of an inner cavity of the handle sheath (8.4) and a rear end of which is fixedly connected to a front end of the push rod (8.6), and a second spring (8.7) sleeved at a position near the front end of the push rod (8.6), a bottom end of the connecting arm (8.2) is provided with cable holes (8.2.1) fixedly connected with a front end of a brake cable of the towed vehicle, a middle part of the detent (8.5) is inserted with a connecting shaft (8.5.1), two ends of the connecting shaft (8.5.1) are respectively rotatably fitted onto inner cavity side walls at the top end of the connecting arm (8.2), there is a front limiter (8.6.1) located on a front side of the second spring (8.7) on the push rod (8.6), and there is a rear limiter (8.1.1) located on a position corresponding to a rear side of the second spring (8.7) on the pipe fitting (8.1).
